(19) United States
(12) Patent Application Publication
(10) Pub. No.: US 2008/0168539 A1
(43) Pub. Date: Jul. 10, 2008

(54) METHODS AND SYSTEMS FOR FEDERATED IDENTITY MANAGEMENT

(76) Inventor: Joseph Stein, Morris Plains, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/620,399

(22) Filed: Jan. 5, 2007

(51) Int. Cl. H04L 9/32

(52) U.S. Cl. 726/5

(57) ABSTRACT

A request for access to a target computer application for which a particular set of user credentials are required is received through a different computer application for which a different set of user credentials are required. Authentication credentials associated with a first session token issued in connection with authenticated user access to the different computer application are mapped to access credentials for the target computer application. Access to functionality provided by the target computer application may be granted based on a second session token issued in response to a correlation between the authentication credentials associated with the different computer application and the access credentials for the target computer application.

### FIELD OF THE INVENTION

The present invention relates to systems and methods for federated identity management within computer networks, and more particularly, to a federated identity concentrator and associated federated identity management modules.

### BACKGROUND

Federated identity management systems allow an individual to use a common user name/password combination (or other personal identification indicia) across heterogeneous computer networks and/or applications in order to conduct transactions. Such systems thus enhance the user's experience inasmuch as the user is freed from the task of having to authenticate him/herself repeatedly when switching between different computer environments. This can be especially beneficial where, as is often the case, different sets of user credentials are required for such authentication with different systems/applications.

As might be inferred from the above, federated identity management systems make use of “digital identities”—virtual representations of a user's real identity created for the purposes of electronic transactions or other interactions. A digital identity is typically accessed or managed through an authentication process involving a user name/password combination. In more sophisticated environments the user name/password combination may be supplemented or replaced by another form of authentication token, such as a shared credential or even a biometric signature.

Unlike one's physical identity, a user's digital identity is often a distributed element, with pieces of information being physically resident at many different places. Moreover, a single user may, and likely will, have multiple different digital identities. These identities are usually created over time and for interacting in many different computer-based environments. Consequently, managing these different “personas” can be a complex matter.

Federated identity management systems provide a means of managing a user's different digital identities. Applications such as single sign-on (SSO) allow a user to enter his/her authentication credentials once, in connection with an initial electronic system/transaction, and have the subsequent authenticated identity follow the user as he/she interacts with other electronic systems, even if those systems are on different computer networks and support different applications/transactions than the original system. An often cited example involves a user making on-line travel reservations. The user may have different digital identities associated with an airline frequent flyer account, a car rental agency and a hotel frequent visitor program. By “federating” these three organizations, which each have their own computer-based systems for allowing transactions with the user, the user may be able to log-in to one account (say the airline frequent flyer account), conduct a transaction, and then travel seamlessly (i.e., without having to supply new or different authentication credentials) to the other accounts where he/she will be automatically authenticated based on the credentials initially supplied in connection with the frequent flyer account.

More generally, and referring to FIG. 1, a user 10 is associated with two (for sake of simplicity, but in fact there can be any number) digital identities, 12 and 14. Assume that identity 12 is associated with the user's work profile and identity 14 is associated with the user's home profile. In the work profile, the user is known to an identity server (or other authenticator) 16, and has access to certain computer services 18. these may include, for example, various servers for e-mail and/or documents, printers, time entry systems, databases, etc. In addition, the user may have access to certain third party computer systems 20a and 20b via an interface 22. The interface may be one or more third party application programs and/or web-based interfaces. All of the facilities accessible to the user in the context of his/her work identity 12 are based on a circle of trust 24 associated with that identity.

In the context of the user's home identity 14, however, a much different circle of trust 26 is associated with a different identity server 28 and a set of home services 30 made accessible thereby. The home services 30 may include home-based printers, servers, media/entertainment systems, broadband Internet connections, etc.

Federated identity management systems rely on the circle of trust concept illustrated in FIG. 1. Just as the individual identity servers 16 and 28 acted as gatekeepers for the various services 18 and 30 available within the respective work and home circles of trust 24 and 26, respectively, groups of service providers that share linked digital identities of a user can permit common access to their resources once a user has been authenticated by a circle of trust identity provider. While authentication typically will take place separately within each circle of trust, identity attributes remain federated throughout the circle, and, with the user's permission, can also be shared between multiple circles.

Not surprisingly, a number of initiatives have been taken in order to address some of the technical and other challenges posed by federated identity management. Among these are the development of the Security Assertions Mark-up Language (SAML), an extensible mark-up language (XML)-based specification developed by the Organization for the Advancement of Structured Information Standards (OASIS), the development of Active Directory Federation Services (ADFS) by Microsoft, the development of various messaging standards by HL7, and the development of Electronic Business using XML (ebXML) standards. SAML provides a common syntax for computer-to-computer communications (termed “assertions”) of user identities, attributes and entitlements. Assertions are issued by SAML authorities (e.g., server-based applications). When a user (or, more generally, an entity, as it may be a computer making the request) successfully requests access to a protected resource (i.e., one for which an access control scheme is in place), a SAML authority issues a digitally signed token which that user (entity) can use for further requests without having to re-authenticate in/for any domain which trusts the SAML authority that issued the token. In essence, the token defines the circle of trust which the user is able to operate within.

### SUMMARY OF THE INVENTION

In one embodiment of the present invention, a request for access to a target computer application for which a particular set of user credentials are required is received through a different computer application for which a different set of user credentials are required. Authentication credentials associated with a first session token issued in connection with authenticated user access to the different computer application are mapped to access credentials for the target computer application. Access to functionality provided by the target computer application (through the different computer application) is granted based on a second session token issued in response to the access credentials for the target computer application. The mapping may be performed in response to receiving attributes associated with the first session token as part of an SAML assertion. For example, the attributes may be included as an AttributeStatement within the SAML assertion.

In a further embodiment of the present invention, a request for access to a target computer system that was made through a first computer system is redirected, for example with a first SAML artifact, so as to direct that request to an artifact receiver service hosted by a trusted relying party. In response to a request by the trusted relying party, a SAML assertion associated with the request is provided. The trusted relying party may then grant permission for the first computer system to participate with the target computer system and request, on behalf of the first computer system, access to that target computer system. Upon receipt of the request for access from the trusted relying party the target computer system may convert authentication information regarding a user of the first computer system into local authentication credentials known by the target computer system; and upon successful authentication of that user at the target computer system using local authentication credentials for the user, grant access to the target computer system.

The information needed for the first SAML assertion concerns the user seeking to access the target computer system and how authentication of the user was performed. For example, identity information concerning the user may be made part of a SubjectStatement in the first SAML assertion. Information concerning how authentication of that user was performed may be made part of an AuthenticationStatement in the first SAML assertion.

The granting of access may be performed by a rules-based engine configured to grant or deny accesses to the target computer system based on definable attributes of the user of the first computer system seeing such access. The attributes of the user may be received as part of the first SAML assertion, compared to stored attribute information, and permission to access the target system granted so long as the stored attribute information matches the attributes received as part of the first SAML assertion.

These and other aspects and features of the present invention are discussed in further detail below.

### BRIEF DESCRIPTION OF THE DRAWINGS

The present invention is illustrated by way of example, and not limitation, in the figures of the accompanying drawings in which:

FIG. 1 illustrates the concepts of digital identities and associated circles of trust upon which federated identity management systems (including such systems as configured in accordance with the present invention) are based;

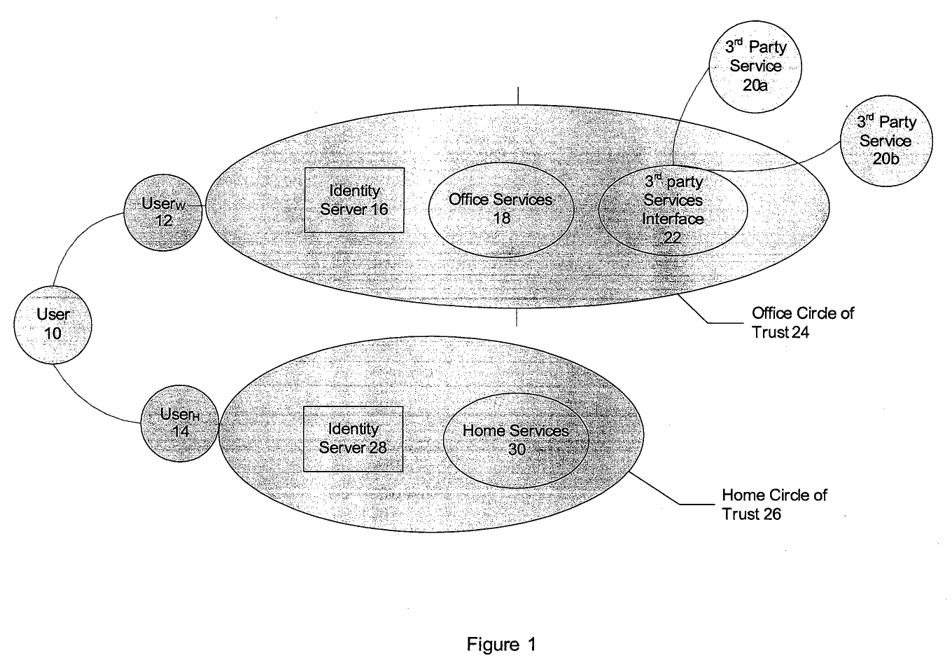

FIG. 2 illustrates an example of a computer system upon or in combination with which embodiments of the present invention may be implemented (e.g., in the form of computer-readable instructions to be stored on and/or executed by said computer system);

FIG. 3 illustrates a three-node identity network wherein each node is in a peer-to-peer relationship with the others in a cross-domain topology;

FIG. 4 illustrates a four-node identity network where each node is in a peer-to-peer relationship with the others in a cross-domain topology;

FIG. 5 illustrates the concept of a circle of trust created through the use of a federated identity concentrator for managing user entitlements to participation with federated application resources;

FIG. 6 illustrates an example of inter-node communications in a computer network including a federated identity concentrator configured in accordance with an embodiment of the present invention;

FIG. 7 illustrates an example of a programmatic interaction of an application consuming an application programming interface (API) of another application which requires a user to re-authenticate to the API;

FIG. 8 illustrates in further detail the inter-node communications for the programmatic interaction depicted in FIG. 7;

FIG. 9 illustrates the introduction of a federated identity concentrator configured in accordance with an embodiment of the present invention into the network first illustrated in FIG. 7; and

FIG. 10 illustrates the inter-node communications for the system depicted in FIG. 9.

### DETAILED DESCRIPTION

Described herein are systems and methods for federated identity management within computer networks. Although discussed with reference to certain illustrated embodiments, the present invention is not meant to be limited thereby. Instead, these are meant to serve merely as examples of the present invention, the true scope of which is reflected in the claims following this description.

Much of the following discussion concerns the actions and interactions of computer resources. Hence, various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, SAML, ebXML), and the like, as well as object-oriented environments such as the Common Object Request Broker Architecture (CORBA), Java™ and the like. Microsoft's Active Directory Federation Services (ADFS) may also be used to implement the present invention. The present invention may be designed to comply with standards set forth by HL7, ebXML, and SAML. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

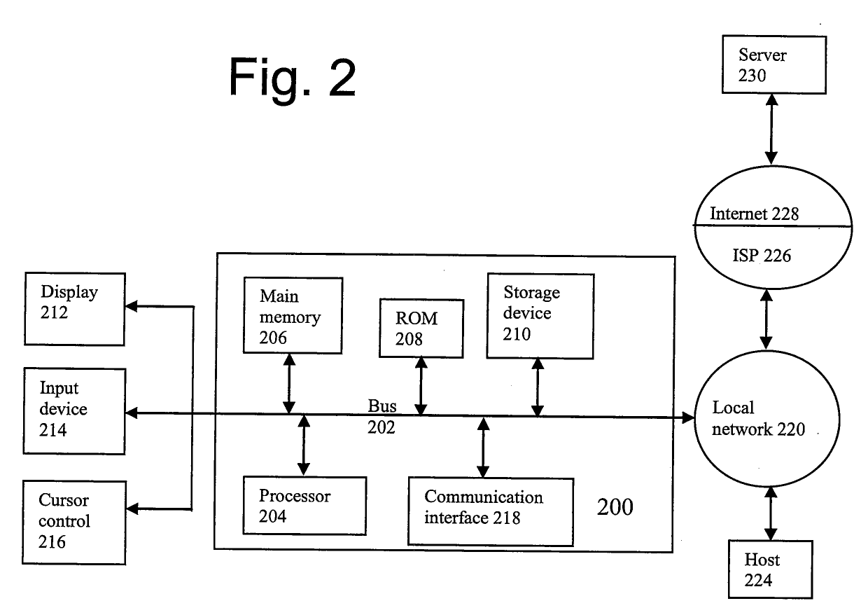

The present invention can be implemented with an apparatus to perform the operations described herein. This apparatus may be specially constructed for the required purposes, or it may comprise a general-purpose computer, selectively activated or reconfigured by a computer program stored in the computer. An example of such a computer system 200 is illustrated in FIG. 2.

Computer system 200 includes a bus 202 (or other communication pathway) and a processor 204 communicatively coupled thereto. Processor 204 is adapted for reading and interpreting computer-readable instructions, such as may be stored for example in main memory 206 (e.g., a random access memory (RAM) or other dynamic storage device) itself being communicatively coupled to bus 202, which instructions when executed by processor 204 cause processor 204 to take actions in accordance with the methods and processes described herein. Main memory 206 also may be used for storing temporary variables or other intermediate information during execution of these instructions by processor 204. Alternatively, or in addition, the computer-readable instructions may be stored (wholly or partially) in read only memory (ROM) 208 or other static storage device, also coupled to the bus 202, and/or in storage device 210 (which may be a magnetic disk or optical disk, for example), likewise communicatively coupled to bus 202. More generally, these various storage devices may be any computer-readable medium, for example a floppy disk, a flexible disk, hard disk, magnetic tape, or any other magnetic medium, a CD-ROM, a DVD-ROM, any other optical medium, punch cards, paper tape, any other physical medium with patterns of holes, a RAM, a PROM, an EPROM, a FLASH-EPROM, any other memory chip or cartridge, or any other medium from which a processor or similar device can read from and/or write to.

Computer system 200 may also include conventional attributes such as a display 212 (e.g., a cathode ray tube (CRT) or a flat panel display), for displaying information to a computer user; an input device 214 (including alphanumeric and other keys, for example) for communicating information and command selections to the processor 204; and a cursor control device 216 (e.g., a mouse, a trackball, or cursor direction keys, etc.) for communicating direction information and command selections to processor 204 and for controlling cursor movement on the display 212.

Computer system 200 may also include a communication interface 218 (e.g., coupled to bus 202), which provides for two-way data communication over a computer network 220. For example, communication interface 218 may be an integrated services digital network (ISDN) card or a modem to provide a data communication connection to a corresponding type of telephone line. Alternatively, communication interface 218 may be a local area network (LAN) interface to provide a data communication connection to a compatible wired and/or wireless LAN. Network 220 may provide a connection to one or more local hosts 224 or to the Internet 228 via equipment operated by an Internet Service Provider (ISP) 226. Using such facilities, computer system 200 can exchange messages/data with other computer systems, such as a server 230.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

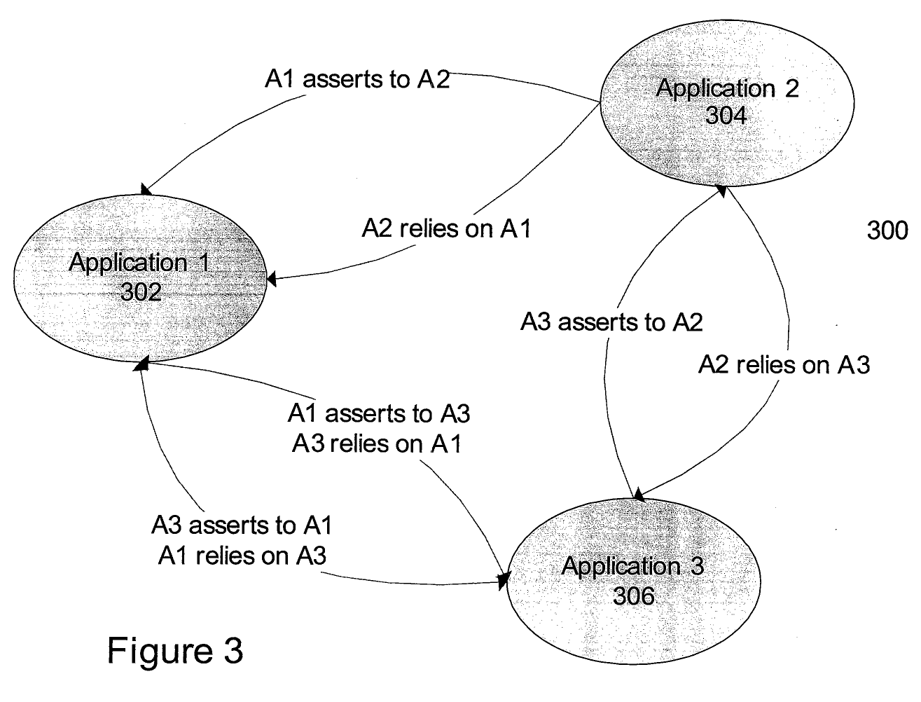

To appreciate the advantages provided by the present federated identity concentrator, consider first the situation depicted in FIG. 3. Shown in this illustration is a three-node identity network 300, wherein each node 302, 304 and 306 is in a peer-to-peer relationship with the others in a cross-domain topology. Each node is associated with a respective application and a user seeking to use these applications must authenticate to each application using a different user name/password combination.

Assume for purposes of this example that application 1, associated with node 302, and application 3, associated with node 306, are applications which the user logs in to and interacts with directly. Application 2, associated with node 304, is an application which the user does not interact with directly. Instead, application 2 is accessed through an application programming interface (API) that exposes functionality which applications 1 and 3 use. This application 2 requires that authentication be passed to it from a user.

As shown in the diagram, application 1 relies on assertions form application 3 and asserts to applications 2 and 3. Application 3 relies on assertions from application 1 and asserts to applications 1 and 2. Application 2 relies on the assertions from applications 1 and 3.

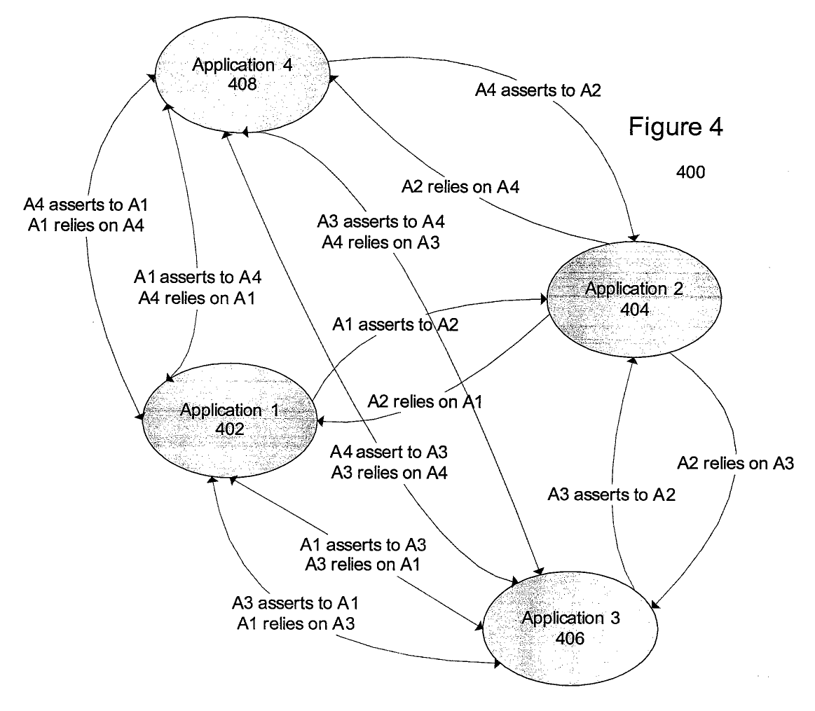

Now, as shown in FIG. 4, by adding just one more node and an associated application the situation becomes many times more complex. This illustration of a four-node identity network 400 where each node 402, 404, 406 and 408, is in a peer-to-peer relationship with the others in a cross-domain topology. Here, application 1, associated with node 402, relies on assertions from applications 3 and 4 and asserts to applications 2, 3 and 4. Application 3, associated with node 406, relies on assertions from applications 1 and 4 and asserts to applications 1, 2 and 4. Application 4, associated with node 408, relies on assertions from applications 1 and 3 and asserts to applications 1, 2 and 3. Application 2, associated with node 404, relies on assertions from all of the other applications.

When one application asserts to another, one of these applications must hold mapping information for the application pair. The mapping information is used to translate user authentication credentials used by a local system into an SAML-defined format that allows for the information to be communicated to remote applications. The information needed for an SAML assertion concerns who was authenticated and how. Thus, in each asserting party (AP)/relying party (RP) relationship, one of the parties must retain ownership of the mapping information for the other.

The separate applications described with reference to FIGS. 3 and 4 then, depending on which node they are associated with, must potentially hold user information about every other node. In simple cases it may be the case that each AP is made responsible for retaining the mapping information. However, in real world situations there are many factors that must be considered before determining which party should hold the mapping information and so it is likely to be a more complex matrix. To understand why this is so consider that if application 3 is asserting to applications 1, 2 and 4, then application 3 must hold the mapping for applications 1, 2 and 4. Consequently, each of these applications would have to trust application 3 directly. Such distribution of trust is a serious consideration in peer-to-peer networks such as those shown in the illustrations.

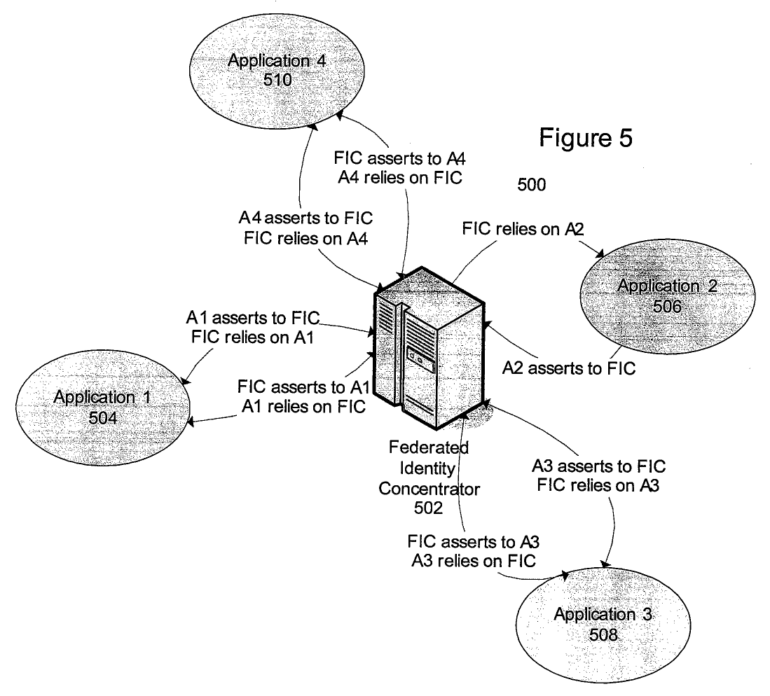

Rather than forcing this distributed trust environment on users and network managers, however, the present invention provides a federated identity concentrator. As shown in FIG. 5, by creating a circle of trust in a system 500 where the concentrator 502 is responsible for managing user entitlements to participation with federated application resources, user identification mapping and assertion transportation and redirection, the environment is made much simpler than was the case above. Now, the maximum number of connections for each application/node has been reduced to two. For example, application 1, associated with node 504, asserts to concentrator 502 and relies on assertions therefrom. Likewise, application 3, associated with node 508, and application 4, associated with node 510, each respectively assert to concentrator 502 and rely on assertions therefrom. Application 2, associated with node 506, relies on assertions from concentrator 502. For its part, the concentrator 502 relies on assertions from applications 1, 3 and 4, and asserts to all of the applications 1-4.

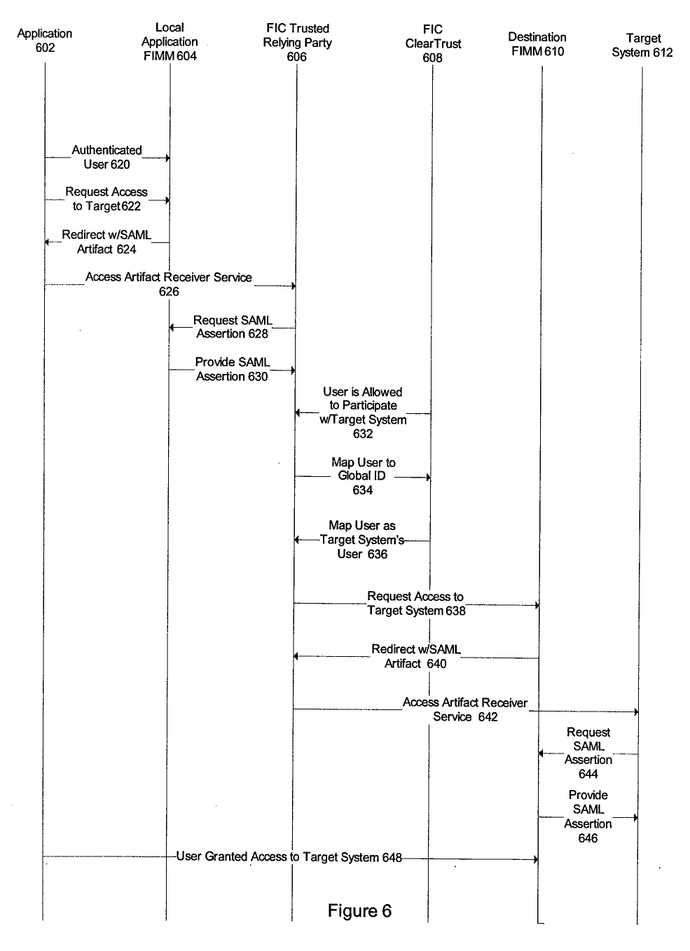

FIG. 6 illustrates further details of the interactions between nodes in the above-described network including the federated identity concentrator. At the outset, an application 602 presents (620) an authenticated user to the local application's asserting federated identity management module (FIMM) 604. A FIMM, in this context, is a local program module (i.e., local to the subject node/application) responsible for communications with the federated identity concentrator. An asserting party's FIMM reads in attributes associated with an authenticated user from a local attribute repository. The authenticated user's name is the user name as it appears in the local authentication system. The attributes are read and placed into internal objects that eventually become an AttributeStatement within an SAML assertion (discussed below). The asserting party FIMM then converts or maps the local user name into a format (e.g., an e-mail address, a Windows™ domain qualified user name, a SAML X.509 subject name, etc.) defined/supported by the SAML specification (e.g., SAML v. 2.0 as originally promulgated by OASIS and subsequently revised from time to time). Name mappings can be many-to-one, many-to-few or one-to-one.

This colloquy is shown in the illustration with the local application 602 requesting (622) access to a target system, the asserting FIMM 604 redirecting the request with a SAML artifact, and the local application making an access (626) to the artifact receiver service. The artifact receiver service is hosted by a trusted relying party, in this case the concentrator 606. The concentrator 606 requests (628) the SAML assertion, which is subsequently provided (630) by the local asserting FIMM 604. The information needed for this assertion concerns the authenticated user and how that authentication was performed. The identity information is made part of the assertion SubjectStatement and the manner of authentication is made part of the AuthenticationStatement in the SAML assertion (630).

In this example, permission for the user to participate with the target system is provided by a portion 608 of the federated identity concentrator that implements the ClearTrust™ solution available from RSA Security Inc. of Bedford, Mass. CleartTrust is a software solution that provides for user account creation and maintenance, profile updates and password setting. It is a rules-based solution that grants or denies user accesses based on definable user attributes. Here, those attributes are received as part of the SAML assertion and, assuming they match the stored attributes, permission to access the target system is granted accordingly.

The relying party module 606 of the concentrator provides (634) the global unique ID for the subject user and, in return, the ClearTrust module 608 provides (636) the necessary credentials for authentication at the target system. Using these credentials, the trusted relying party module 606 requests access (638) to the target system on the user's behalf. The request is made to the target system's receiving FIMM 610, which extracts the list of attribute values and names and the local user name of the now authenticated user. The attributes may be written to a local repository or, more usefully, to an HTTP cookie or similar object. Thus, the relying party FIMM performs an inverse function of the asserting party FIMM. It starts with the SAL assertion and converts the information about authentication back into a format known by the local system.

The relying party FIMM 610 of the target system now redirects (640) the requested access (with an SAML artifact) so that the concentrator directs the request for access (642) to the target system 612. This request accesses the artifact receiver service at the target system such that the target system interrogates (644) its local relying party FIMM 610 for the SAML assertion that will provide the local authentication credentials and that SAML assertion is provided (646) in response. Upon successful authentication at the target system in the target's local credentials, the user is granted access (648) to the target system.

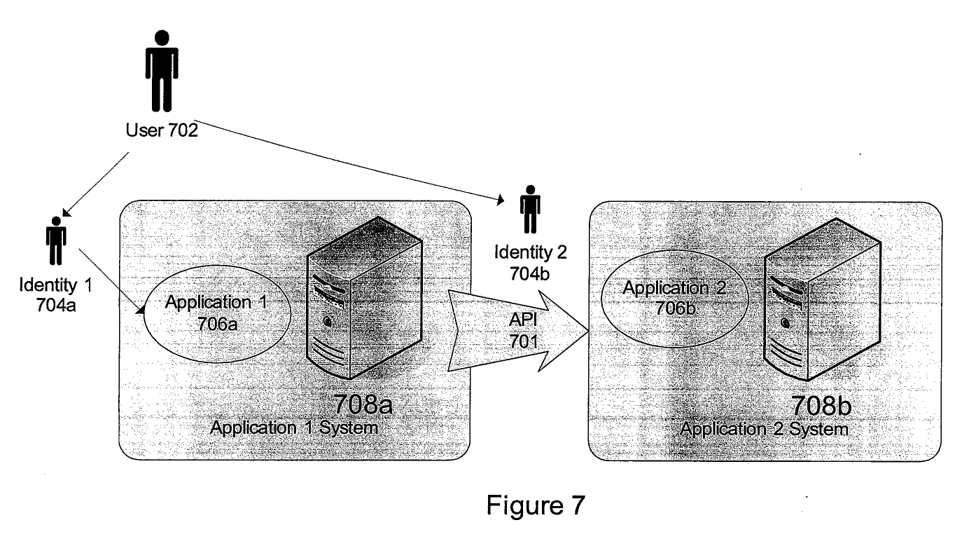

A further example of the benefits provided by the present invention may be understood by considering the use of programmatic interactions of an application consuming an API of another application. In such cases, users often encounter the need to re-authenticate to the API, for example using a session identifier or security token. For example, in the scenario illustrated in FIG. 7, assume that a user 702 has two digital identities; the first identity 704a is associated with application 706a that runs on system 708a, and the second identity 704b is associated with application 706b that runs on system 708b. The first application 706a, which may be a web-based application, consumes and uses the API 710 for the second application 706b (which may also be a web-based application, in which case the API may be a web service description language (WSDL)-based client code). Before deployment of a federated identity network, users would have to log in separately to each application. For example, when application 706a needed to call the functionality of application 706b, the user 702 would be prompted to enter his/her log in credentials for the second application.

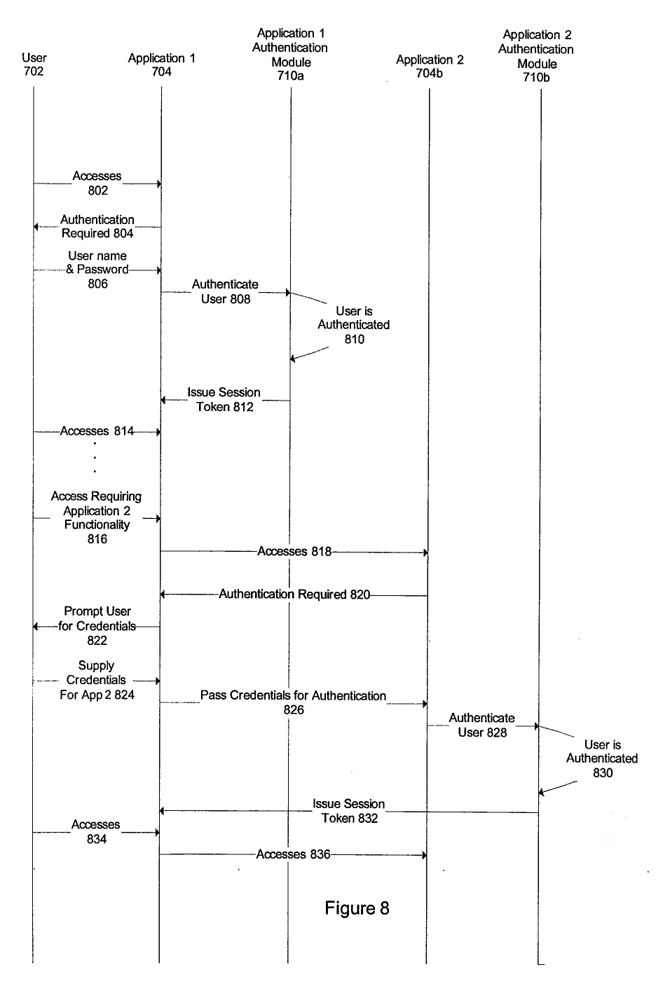

FIG. 8 illustrates the inter-node communications present in the above-described usage scenario in greater detail. As shown, the user 702 seeks to access (802) the first application 704a, which prompts the user to enter his/her authentication credentials (804). The user supplies these credentials (806), which are passed (808) to the first application's authentication module 710a. Assuming the credentials are valid, the user is authenticated (810) and a session token is issued (812). Using this token the user accesses (814) the first application.

At some point the user seeks at access (816) functionality from the second application 704b while remaining in the context of the first application. The first application 704a proxies the access request (818) and, in response, the second application 704b issues a prompt (820) for the user to supply the necessary authentication credentials. This prompt is relayed (822) by the first application to the user, who supplies (824) the necessary credentials. The first application passes (826) the credentials through to the second application (via the API discussed above), which makes an authorization request (828) to its authentication module 710b.

Assuming the credentials are correct, the authentication module 710b associated with the second application authenticates (830) the user and the second applications issues (832) a unique session token to the first application for use during the access period. The user is then free to access (834) the functionality of the second application through the first application, which passes (836) such access requests as shown. Note that the use of session tokens with respect to each of the applications relieves the user from having to re-authenticate to these applications during the access session, so long as the user's log in state does not change or expire.

The credentials that the user must supply to gain access to the two different applications in the above-described scenario are often different from one another. Further, they may be complex sets of credentials requiring not only user name/password combinations but also unique token or even biometric identifications. When a federated identity network is introduced into the above-described situation, the need for the user to re-authenticate to gain access to the second application is eliminated.

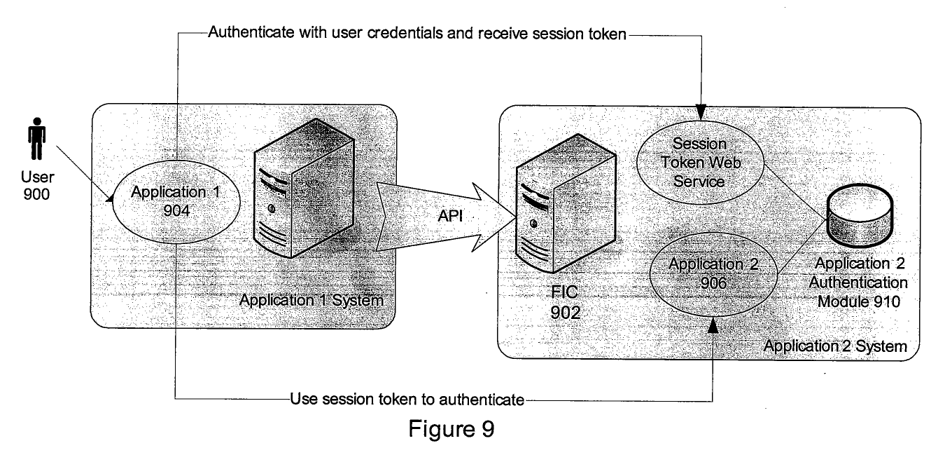

Referring to FIG. 9, the introduction of a federated identity concentrator 902 within the overall system means that the session token created on behalf of a user 900 for one application (e.g., application 904) can be used as an authentication mechanism that will allow the user to access a second application 906 even if the user's authentication credentials for the two applications are different.

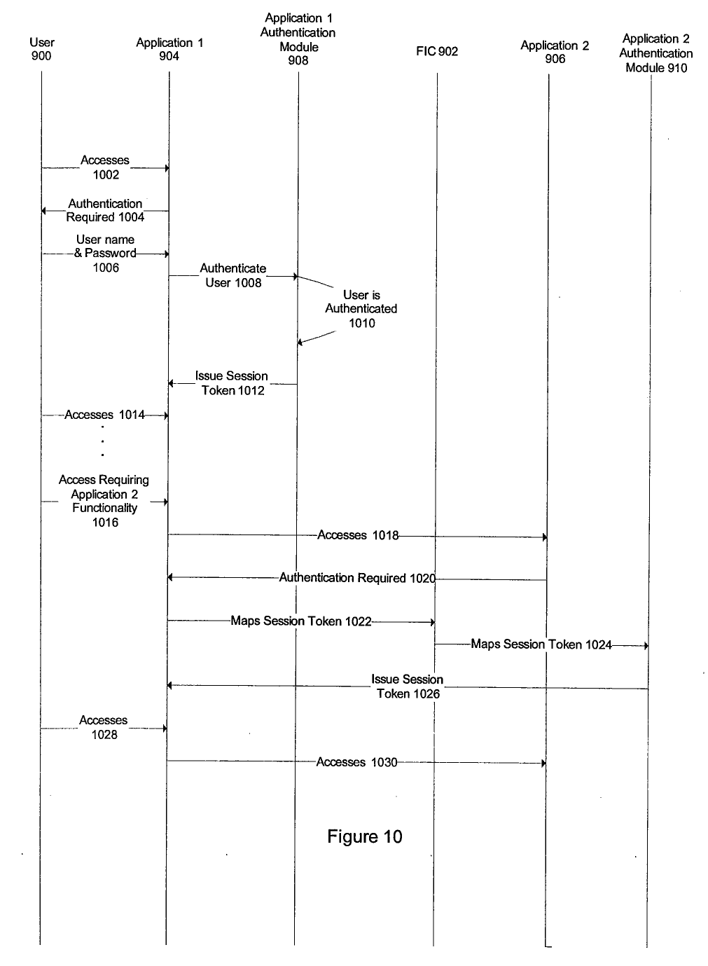

Thus, and referring now also to FIG. 10, when user 900 seeks to access (1002) application 902, that application prompts (1004) the user to enter his/her authentication credentials for that application. The user supplies (1006) these credentials and they are passed (1008) to the application's authentication module 908 for verification. Assuming the credentials are valid, the user is authenticated (1010) and a session token is issued (1012) by application 904. This session token allows the user to access (1014) the functionality associated with the first application 904.

Now, when the user seeks to access (1016) functionality from the second application 906 through the first application, the first application proxies the access request (1018). In response, the second application will issue a request (1020) for authentication. If the federated identity concentrator were not present, this request would have resulted in the user having to enter his/her associated credentials for the second application. This time, however, the first application 904 maps (1022) the previously issued session token for the user to the federated identity concentrator 902, which passes (1024) the mapping to the second application 910.

Based on this mapping, the second application's authentication module 910 is able to authenticate the user and issue (1026) an associated session token. Now, when the user requests access (1028) to functionality provided by the second application, the first application is able to use that session token to make the accesses (1030) to the second application.

Thus, methods and systems for federated identity management within computer networks have been described. Although discussed with respect to various illustrated embodiments, however, the present invention should not be limited thereby and, instead, measured only in terms of the following claims.

What is claimed is:

1. A method, comprising:
receiving, through a first computer-based application for which a first set of user credentials are required in order to gain access to functionality provided by said first computer-based application, a request for access to a second computer application for which a second set of user credentials are required in order to gain access to functionality provided by said second computer-based application;
mapping, in response to a request for authentication to the second computer-based application, authentication credentials associated with a first session token issued in connection with authenticated user access to the first computer-based application to access credentials for the second computer-based application; and
allowing access to functionality provided by the second computer-based application through the first computer-based application based on a second session token issued in response to the access credentials for the second computer-based application.

2. The method of claim 1, wherein the mapping is performed in response to receiving attributes associated with the first session token as part of an SAML assertion.

3. The method of claim 2, wherein the attributes are included as an AttributeStatement within the SAML assertion.

4. A method, comprising:
redirecting, with a first Security Assertions Mark-up Language (SAML) artifact, a first request for access to a target computer system that was made through a first computer system so as to direct said first request to an artifact receiver service hosted by a trusted relying party;
providing, in response to a second request by the trusted relying party, a SAML assertion associated with the request;
granting, by the trusted relying party, permission for the first computer system to participate with the target computer system and requesting, by the trusted relying party on behalf of the first computer system, access to the target computer system;
receiving, at the target computer system, the first request for access from the trusted relying party and converting authentication information regarding a user of the first computer system into local authentication credentials known by the target computer system; and
upon successful authentication at the target computer system using local authentication credentials for the user, granting access to the target computer system.

5. The method of claim 4, wherein the information needed for the first SAML assertion concerns the user seeking to access the target computer system and how authentication of the user was performed.

6. The method of claim 5, wherein identity information concerning said user is made part of a SubjectStatement in the first SAML assertion.

7. The method of claim 5, wherein information concerning how authentication of said user was performed is made part of an AuthenticationStatement in the first SAML assertion.

8. The method of claim 4, wherein said granting is performed by a rules-based engine configured to grant or deny accesses to the target computer system based on definable attributes of the user of the first computer system seeking such access.

9. The method of claim 8, wherein the attributes of the user of the first computer system are received as part of the first SAML assertion.

10. The method of claim 9, wherein the attributes of the user of the first computer system received as part of the first SAML assertion are compared to stored attribute information and permission to access the target system is granted so long as the stored attribute information matches the attributes received as part of the first SAML assertion.

11. The method of claim 9, wherein the trusted relying party provides a unique identifier for the user and, in return, the rules-based engine provides credentials for authentication of the user at the target computer system.

12. The method of claim 4 further comprising writing the attributes to a local repository.

13. The method of claim 4 further comprising writing the attributes to an HTTP cookie.

14. The method of claim 4 wherein, prior to authentication at the target computer system, the first request for access from the trusted relying party is redirected to an SAML artifact receiver service associated with the target computer system.

15. The method of claim 14 wherein, the artifact receiver service associated with the target computer system causes the target computer system to interrogate a local relying party for a second SAML assertion to provide the local authentication credentials.

16. A method comprising:
receiving authentication information from a user;
granting access to the user to a first application;
receiving a request from the user to access a second application;
determining a correlation between a first identity of the user with respect to the first application stored in a central repository of user information and a second identity of the user with respect to the second application stored in the central repository of user information; and
granting access to the user to the second application based on the correlation of the first identity of the user and the second identity of the user.

17. The method of claim 16, wherein the request from the user is directed to the first application.

18. The method of claim 16, wherein the request is transmitted to the central repository of user information by the first application.

19. The method of claim 16, wherein the request is transmitted to the central repository of user information by the user.

20. The method of claim 16, wherein determining the correlation between the first identity of the user and the second identity of the user is performed at the central repository of user information.

21. The method of claim 16, further comprising receiving a first application access request from a user and prompting the user to enter authentication information.

22. The method of claim 16, wherein the central repository of user information includes the correlation between the first identity of the user and the second identity of the user.

23. The method of claim 16, wherein access is granted to the user to the first application based on an analysis of the authentication information by the first application.

24. The method of claim 16, wherein granting access to the user to the second application further comprises creating a token.

25. The method of claim 24, further comprising storing the token on a user computer.

26. The method of claim 16, wherein determining the correlation is accomplished using an authentication application.

27. The method of claim 26, wherein the request is transmitted to the authentication application by the first application.

28. The method of claim 26, further comprising receiving a first application access request from the user to access the first application.

29. The method of claim 26, wherein the authentication application contacts the central repository of user information.

30. The method of claim 26, wherein the correlation between the first set of information and the second set of information is determined by the authentication application.

31. A method comprising:
receiving authentication information from a user;
granting access to the user to a first application;
receiving a plurality of requests from a user to access a plurality of applications;
determining a correlation between a first identity of the user with respect to the first application stored in a central repository of user information and the identity of the user with respect to each of a plurality of applications stored in a central repository of user information; and
granting access to the user to one or more of the plurality of applications based on the correlation of the first identity of the user and the identity of the user with respect to a corresponding one or more of the plurality of applications.

32. A computer program product used with a processor, the computer program product comprising:
computer-readable medium, including computer readable program code embodied therein used when implementing a method for managing the identity of a user over multiple applications, the computer-readable medium including:
computer readable program code that receives authentication information from a user;
computer readable program code that grants access to the user to a first application;
computer readable program code that receives a request from the user to access a second application;
computer readable program code that determines a correlation between a first identity of the user with respect to the first application stored in a central repository of user information and a second identity of the user with respect to the second application stored in the central repository of user information; and
computer readable program code that grants access to the user to the second application based on the correlation of the first identity of the user and the second identity of the user.

33. The computer program product of claim 32, wherein the request from the user is directed to the first application.

34. The computer program product of claim 32, wherein the request is transmitted to the central repository of user information by the first application.

35. The computer program product of claim 32, wherein the request is transmitted to the central repository of user information by the user.

36. The computer program product of claim 32, wherein determining the correlation between the first identity of the user and the second identity of the user is performed at the central repository of user information.

37. The computer program product of claim 32, further comprising computer readable program code that receives a first application access request from a user and prompts the user to enter authentication information.

38. The computer program product of claim 32, wherein the central repository of user information includes the correlation between the first identity of the user and the second identity of the user.

39. The computer program product of claim 32, wherein access is granted to the user to the first application based on an analysis of the authentication information by the first application.

40. The computer program product of claim 32, wherein the step of granting access to the user to the second application further comprises creating a token.

41. A system for managing access on a network, the system comprising:
a first application coupled to the network, the first application receiving authentication information from a user and granting access to the user based on the authentication information;
a second application coupled to the network; and
a central repository of user information coupled to the network and including a first identity of the user with respect to the first application and a second identity of the user with respect to the second application;
wherein the second application receives a request for access of the second application by the user and grants access to the user based on the correlation of the first identity of the user and the second identity of the user.
